(19) United States
(12) Patent Application Publication
(10) Pub. No.: US 2008/0113576 A1
(43) Pub. Date: May 15, 2008

(54) Method of manufacturing a field emission device using half tone photomask

(76) Inventor: In-Taek Han, Yongin-si (KR)

Correspondence Address: ROBERT E. BUSHNELL, 1522 K STREET NW, SUITE 300, WASHINGTON, DC, 20005-1202, US

(21) Appl. No.: 11/896,644

(22) Filed: Sep. 4, 2007

(30) Foreign Application Priority Data
Nov. 14, 2006 (KR) 10-2006-0112452

(51) Int. Cl. H01J 9/02

(52) U.S. Cl. 445/23

(57) ABSTRACT

A method of manufacturing field emission devices using a half tone photomask includes: sequentially forming lower electrodes, an insulation layer, an upper electrode material layer and a photoresist on a substrate; arranging a half tone photomask above the photoresist and exposing the photoresist to light and developing the photoresist, the photomask having a predetermined pattern including a first pattern shielding light and a second shape through which a portion of light is transmitted; forming a plurality of insulation layer holes exposing the lower electrodes in the insulation layer by etching the upper electrode material layer exposed by the developed photoresist and the insulation layer below the upper electrode material layer; etching the developed photoresist, the developed photoresist remaining only on a portion of the upper electrode material layer which is to form the upper electrodes; forming the upper electrodes by etching the upper electrode material layer through the etched photoresist; and removing the photoresist.

### CLAIM OF PRIORITY

This application makes reference to, incorporates the same herein, and claims all benefits accruing under 35 U.S.C. §119 from an application for MANUFACTURING METHOD OF FIELD EMISSION DE VICE USING HALF TONE PHOTOMASK earlier filed in the Korean Intellectual Property Office on 14 Nov. 2006 and there duly assigned Serial No. 0-2006-0112452.

### BACKGROUND OF THE INVENTION

1. Field of the Invention

The present invention relates to a method of manufacturing a field emission device, and more particularly, the present invention relates to a method of manufacturing a field emission device using a half tone photomask and having a reduced number of manufacturing processes and reduced manufacturing costs.

2. Description of the Related Art

A field emission device refers to a device in which electrons are emitted from an emitter formed on a cathode as a strong electric field is formed around the emitter. A representative application field of field emission devices is a field emission display which is a flat panel display. Field emission displays display images by colliding electrons emitted from a field emission device against a phosphor layer formed on an anode. Field emission displays are regarded as next-generation displays along with Liquid Crystal Displays (LCDs), Plasma Display Panels (PDPs), etc. due to field emission displays being as thin as a few centimeters, in addition to the wide viewing angle, low consumption of power, low costs, etc.

Also, a field emission device can be applied to a BackLight Unit (BLU) of LCDs. LCDs are devices displaying images on a front side thereof using light which is generated from a light source disposed on a rear side thereof and transmits light through liquid crystals controlling light transmittance. Examples of the light source being disposed on the rear side include a field emission type backlight unit in addition to a Cold Cathode Fluorescent Lamp (CCFL), an External Electrode Fluorescent Lamp (EEFL), Light Emitting Diode (LED), etc. A field emission type backlight unit has the same driving and emission mechanisms as a field emission display. A field emission type backlight unit and a field emission display differ only in that the former does not display images but functions as a light source. The field emission type backlight units are regarded as a next-generation backlight unit of LCDs due to their thinness, low manufacturing costs, and a position-selective brightness controlling function. Also, a field emission device can be applied to various kinds of systems such as an X-ray tube, a microwave amplifier, a flat lamp, etc.

FIG. 1A is a plan view of a conventional field emission device and FIG. 1B is a cross-sectional view taken along line I-I′ of FIG. 1A.

Referring to FIGS. 1A and 1B, a field emission device has a structure in which lower electrodes 12, an insulation layer 14 and upper electrodes 16 are sequentially deposited on a substrate 10. The lower electrodes 12 are cathodes and the upper electrodes 16 are gate electrodes for electron extraction. A plurality of insulation layer holes 30 which expose the lower electrodes 12 are formed in the insulation layer 14 and upper electrode holes 40 connected to the insulation layer holes 30 are formed in the upper electrodes 16. Emitters (not shown) which emit electrons are formed on the lower electrodes 12 in the insulation layer holes 30. When a strong electric field is applied between the emitters formed on the lower electrodes 12 and the upper electrodes 16, electrons are emitted from the emitters.

Conventionally, at least three photomasks are required to manufacture the above described field emission device. More specifically, the three photomasks are needed to form the lower electrodes 12, upper electrodes 17 and insulation layer holes 30. Furthermore, an additional photomask is required to form emitters inside the insulation layer holes 30. Likewise, many photomasks are required to manufacture a field emission device conventionally, and thus the manufacturing process becomes complex and manufacturing costs increase as the number of light exposing and aligning processes increases.

### SUMMARY OF THE INVENTION

The present invention provides a method of manufacturing field emission devices using a half tone photomask, which results in a reduction of the manufacturing costs and the number of manufacturing processes.

According to an aspect of the present invention, a method of manufacturing field emission devices is provided, the method including: sequentially forming lower electrodes, an insulation layer, an upper electrode material layer and a photoresist on a substrate; arranging a half tone photomask above the photoresist and exposing the photoresist to light and developing the photoresist, the photomask having a predetermined pattern including a first pattern shielding light and a second shape through which a portion of light is transmitted; forming a plurality of insulation layer holes exposing the lower electrodes in the insulation layer by etching the upper electrode material layer exposed by the developed photoresist and the insulation layer below the upper electrode material layer; etching the developed photoresist, the developed photoresist remaining only on a portion of the upper electrode material layer which is to form the upper electrodes; forming the upper electrodes by etching the upper electrode material layer through the etched photoresist; and removing the photoresist.

The photoresist may be a positive photoresist.

The lower electrodes can be formed by depositing a lower electrode material layer on the substrate and patterning the lower electrode material layer in a predetermined shape.

The first and second patterns can be formed on a transparent substrate. The first pattern can be formed in a shape corresponding to the upper electrodes, and a plurality of through-holes exposing the transparent substrate can be formed in the first pattern. The through-holes may be formed in a shape corresponding to the insulation layer holes. The second pattern can be formed in a region except for the region of the first pattern. The light transmittance of second pattern can be in a range of 25 to 80%.

The photoresist located under the through-holes of the first pattern may be exposed to light and developed so as to expose the upper electrode material layer, and the photoresist located under the second pattern may be exposed to light and developed to a depth corresponding to the light transmittance of the second pattern during the exposing of the photoresist to light.

The etching of the developed photoresist can be performed by a plasma etching method including Reactive Ion Etching (RIE).

### BRIEF DESCRIPTION OF THE DRAWINGS

A more complete appreciation of the present invention and many of the attendant advantages thereof, will be readily apparent as the present invention becomes better understood by reference to the following detailed description when considered in conjunction with the accompanying drawings in which like reference symbols indicate the same or similar components, wherein:

FIGS. 1A and 1B are respectively a plan view and a cross-sectional view of a conventional example of field emission devices; and

FIGS. 2A through 12B are views for explaining a method of manufacturing field emission devices according to an embodiment of the present invention.

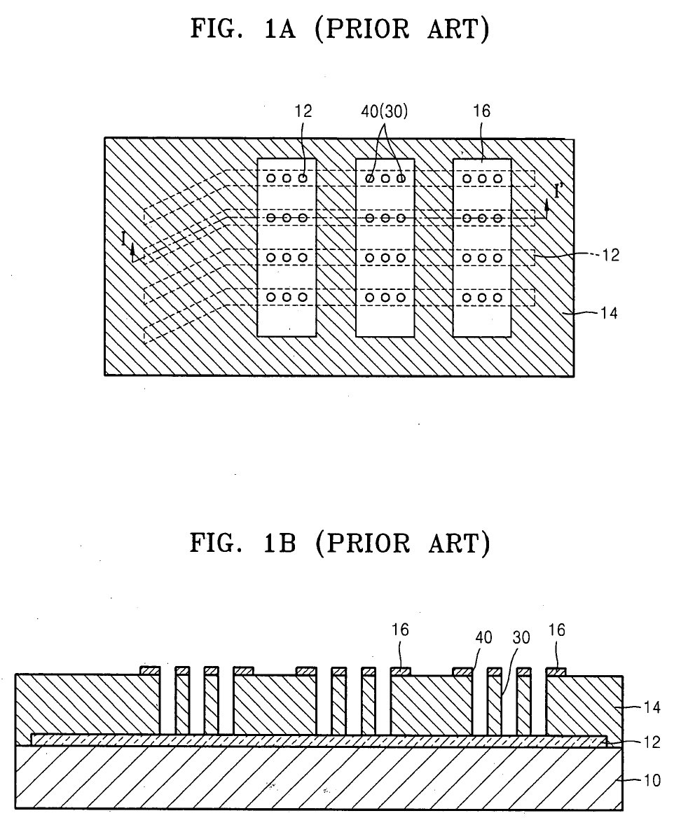

### DETAILED DESCRIPTION OF THE INVENTION

The present invention will now be described more fully with reference to the accompanying drawings, in which exemplary embodiments of the present invention are shown. Like reference numerals used in the drawings refer to like elements. The size of elements may have been exaggerated for clarity of explanation.

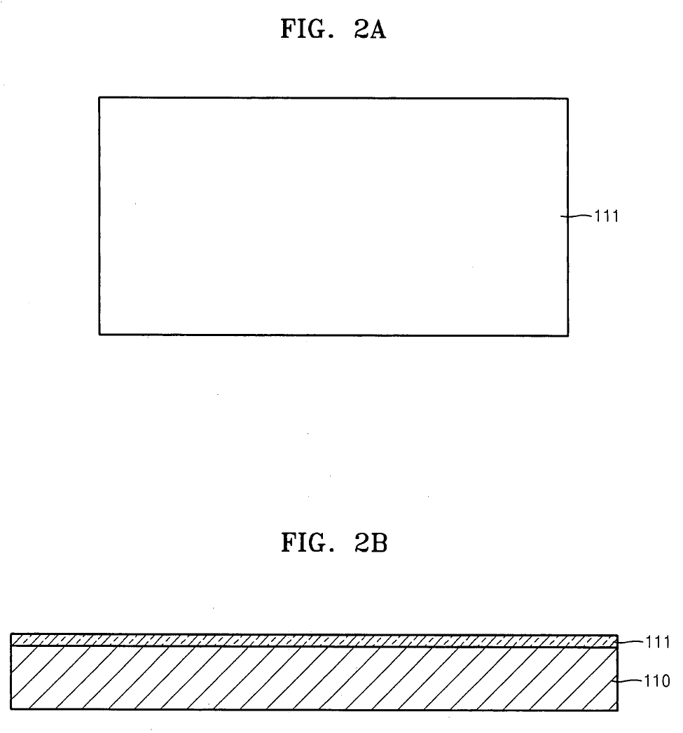

FIGS. 2A through 12B are views for explaining a method of manufacturing field emission devices according to embodiments of the present invention.

FIG. 2A is a plan view of a state in which a lower electrode material layer 111 is formed on a substrate 110, and FIG. 2B is a cross-sectional view thereof. Referring to FIGS. 2A and 2B, a predetermined material is deposited on the substrate 110 to form the lower electrode material layer 111. A glass substrate can generally be used as the substrate 110, or a plastic substrate can also be used. The lower electrode material layer 111 may be formed of a metal, such as Cr, Ag, Al, Au, etc. or a transparent conductive material, such as Indium Tin Oxide (ITO). However, the present invention is not limited thereto.

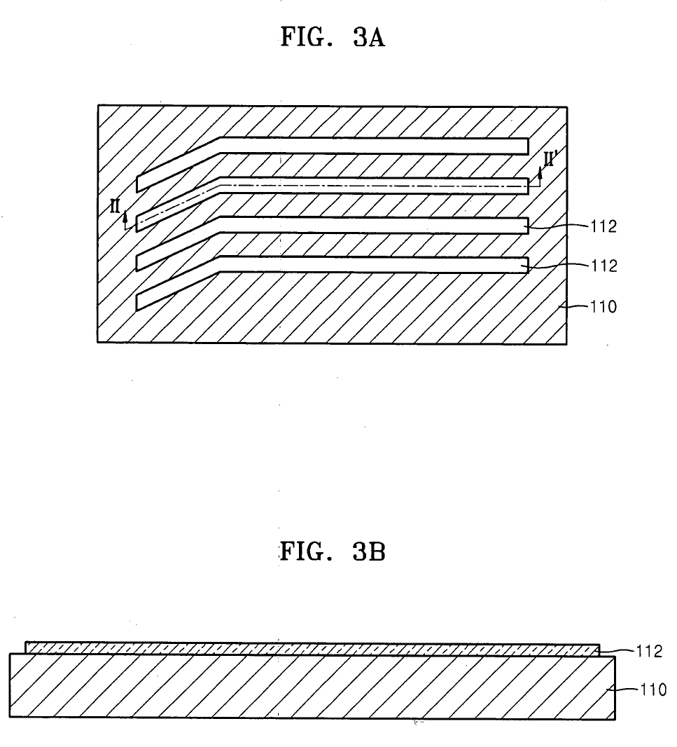

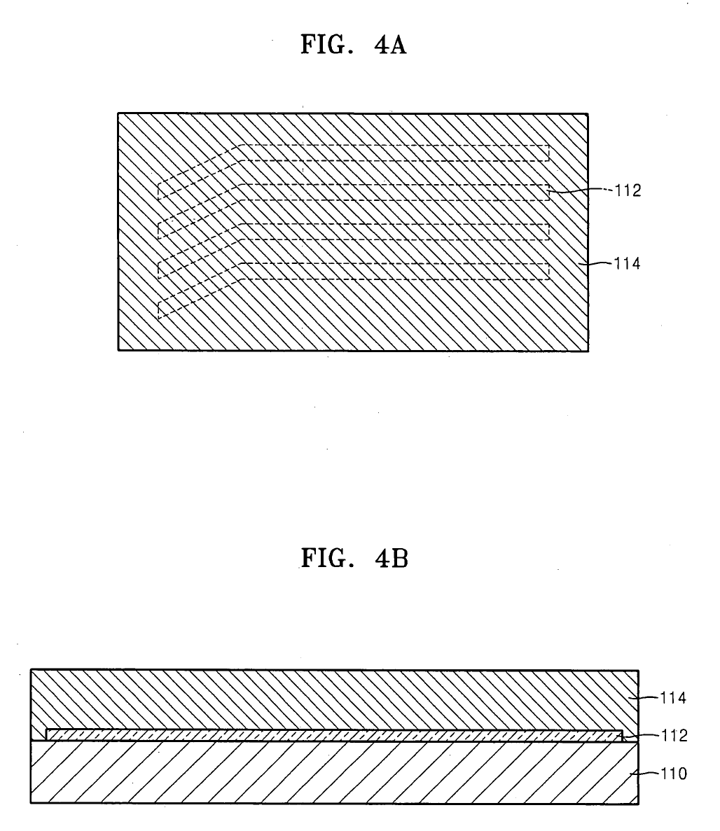

FIG. 3A is a plan view of a state in which lower electrodes 112 are formed on the substrate 110, and FIG. 3B is a cross-sectional view taken along line II-II′ of FIG. 3A. Referring to FIGS. 3A and 3B, the lower electrodes 112 can be formed by patterning the lower electrode material layer 111 in a predetermined shape, for example, a stripe shape. The lower electrodes 112 can be cathodes. One end portion of the lower electrodes can be a pad region, which is connected to an external power supply, and another portion except for the pad region can be an active region where emitters are formed. FIGS. 4A and 4B are respectively a plan view and a cross-sectional view of a state in which an insulation layer 114 is formed on the substrate 110. Referring to FIGS. 4A and 4B, the insulation layer 114 can be formed to cover the lower electrodes 112 to a predetermined thickness.

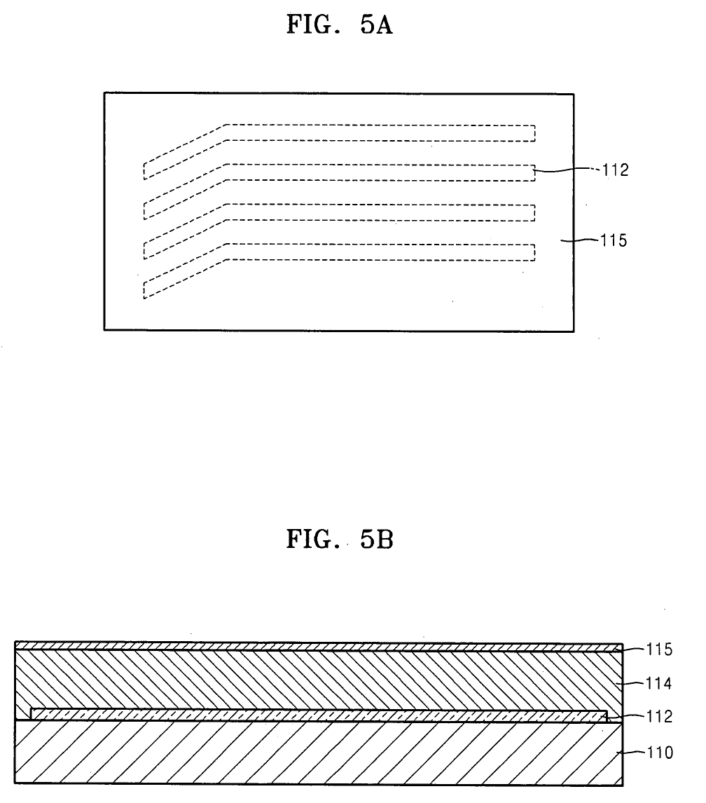

FIGS. 5A and 5B are respectively a plan view and a cross-sectional view of a state in which an upper electrode material layer 115 is formed on the insulation layer 114. Referring to FIGS. 5A and 5B, the upper electrode material layer 115 may be formed by depositing a predetermined material on the upper surface of the insulation layer 114. The upper electrode material layer 115 may be formed of, for example, Cr, Ag, Al, or Au. However, the present invention is not limited thereto.

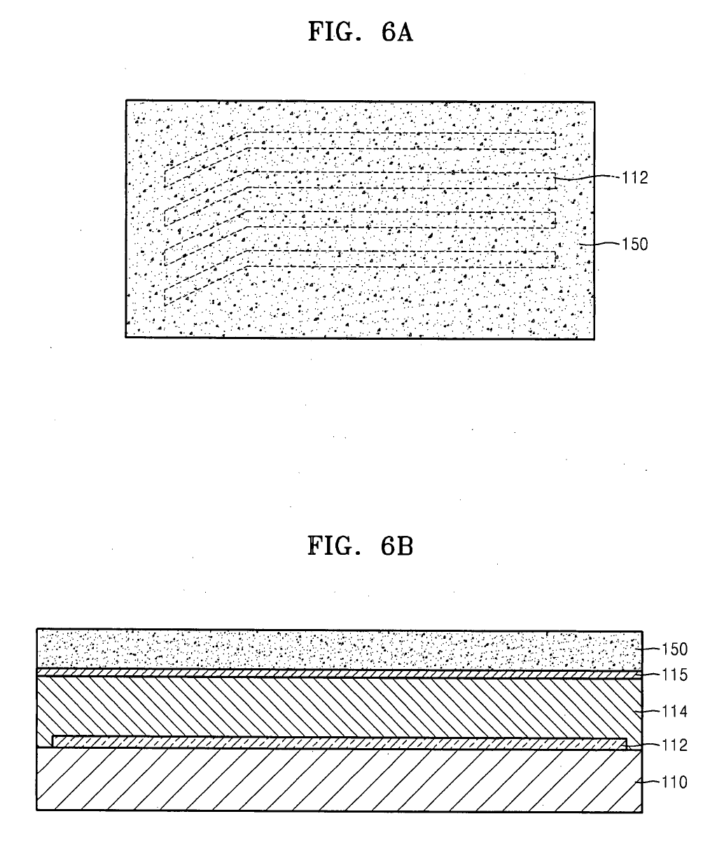

FIGS. 6A and 6B are respectively a plan view and a cross-sectional view of a state in which a photoresist 150 is formed on the upper electrode material layer 115. Referring to FIGS. 6A and 6B, the photoresist 150 is coated on the upper electrode material layer 115 to a predetermined thickness. The photoresist 150 may be a positive photoresist in which the exposed portion is removed by a developer.

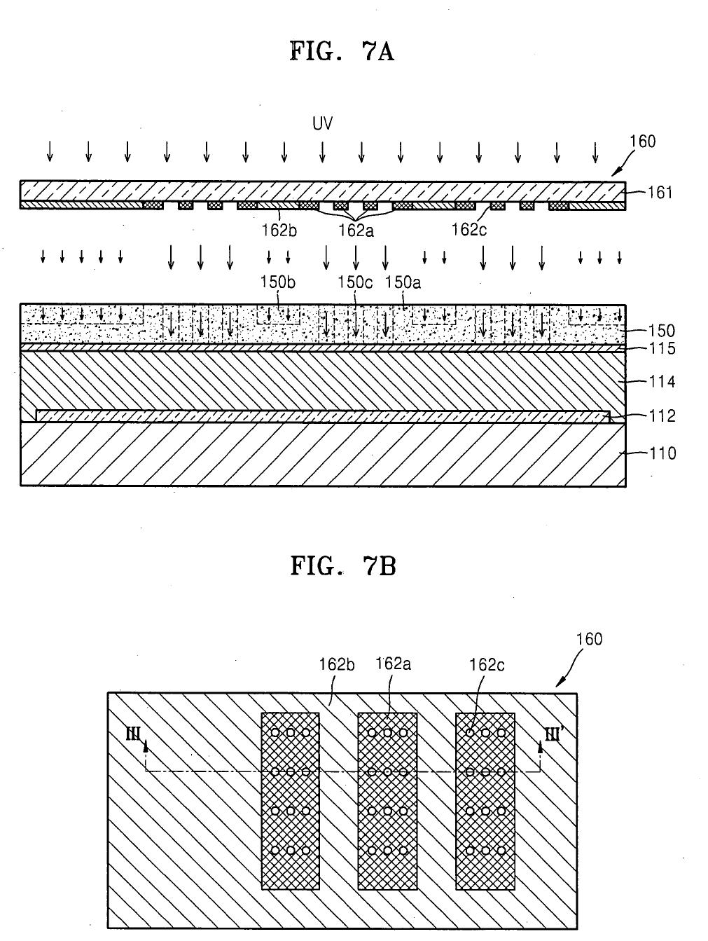

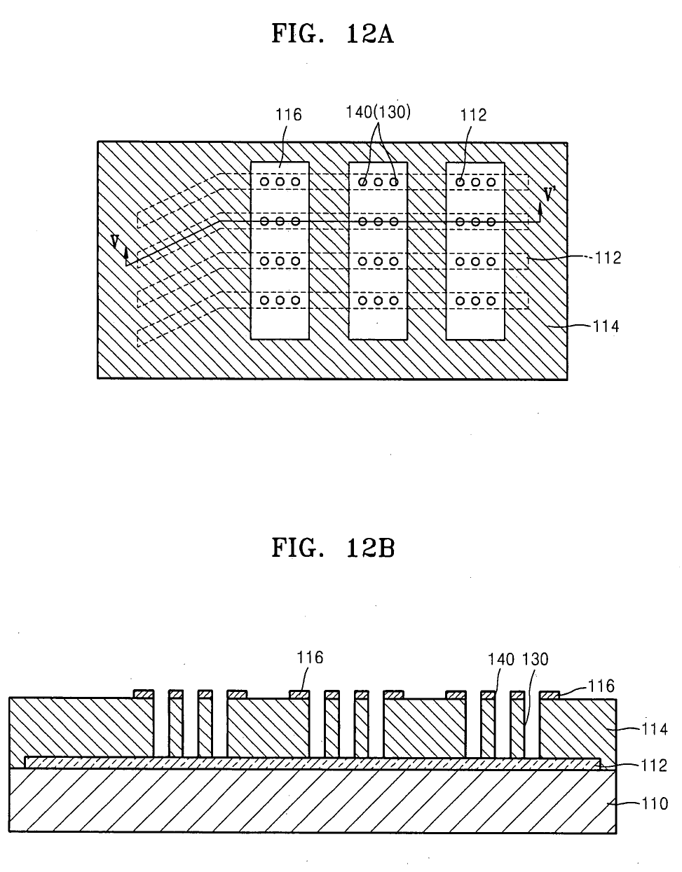

Referring to FIG. 7A, a halftone photomask 160 is arranged above the photoresist 150 and the photoresist 150 is exposed to light and developed. FIG. 7B is a plan view of the half tone photomask 160 and the half tone photomask 160 of FIG. 7A is a cross-sectional view taken along line III-III′ of the half tone photomask 160 of FIG. 7B. Referring to FIGS. 7A and 7B, the half tone photomask 160 includes a transparent substrate 161 and a first pattern 162a and a second pattern 162b formed in predetermined shapes on the substrate 161. The first pattern 162a is formed to block light incident on it and the second pattern 162b is formed so that a portion of light can be transmitted through it, where the light transmittance of the second pattern 162b can be in the range of approximately 25 to 80%. The first pattern 162a is formed in a shape corresponding to an upper electrode 116 as described below (refer to FIGS. 12A and 12B) and a plurality of through-holes 162c, which expose the transparent substrate 161, are formed therein. The through-holes 162c may be formed in a shape corresponding to insulation layer holes 130 as described below (refer to FIGS. 12A and 12B). The second pattern 162b is formed on the region of the transparent substrate 161 except for where the first pattern 162a has been formed.

Next, the half tone photomask 160 is arranged above the photoresist 150 and ultraviolet (UV) rays are projected from above the half tone photomask 160. Then, the UV rays reach to a light transmission region 150c located under the through-holes 162c without almost any loss and the bottom of the light transmission region 150c located under the through-holes 162c can be exposed to light. However, UV rays do not reach a light shield region 150a located under the first pattern 162a except for the through-holes 162c, and thus the light shield region 150a is not exposed to light. A partial light transmission region 150b located under the second pattern 162b is exposed as deep as UV rays reach and the depth to which the UV rays reach depends on the intensity of the UV rays transmitting the second pattern 162b.

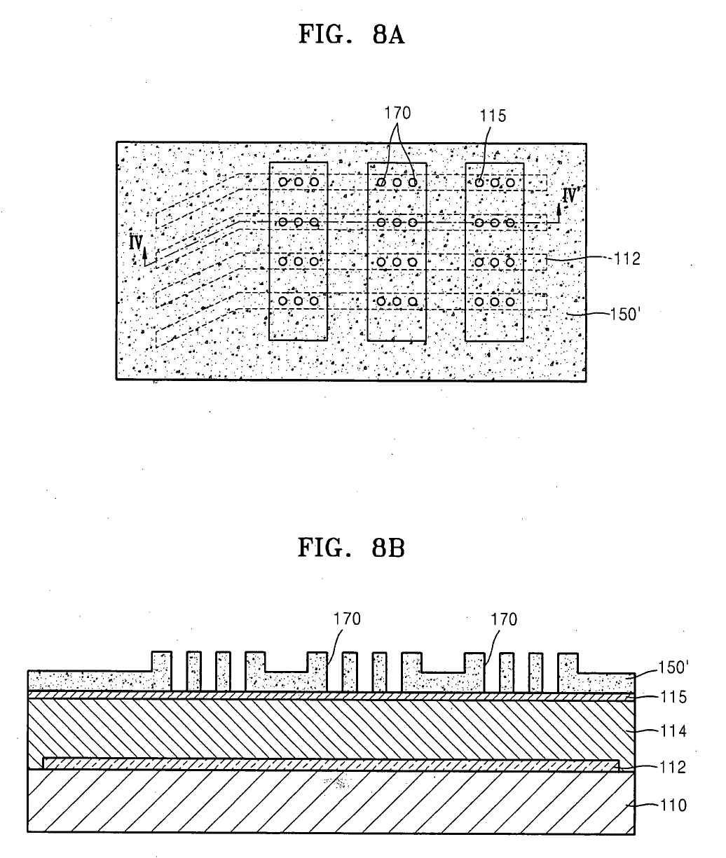

A developed photoresist 150′, as illustrated in FIGS. 8A and 8B, can be obtained by developing the exposed photoresist 150. FIG. 8B is a cross-sectional view taken along line IV-IV′ of FIG. 8A. Specifically, the light transmission region 150c of the photoresist 150 is completely dissolved by a developer so as to expose the upper electrode material layer 115. As a result, a plurality of resist holes 170 in a shape corresponding to the through-holes 162c are formed in the developed photoresist 150′. However, the light shield region 150a of the photoresist 150 is not exposed to light and thus it is not dissolved by the developer. In the partial light transmission region 150b of the photoresist 150, only the portion which is exposed to light to a predetermined depth is dissolved by the developer. Accordingly, a difference in height between the light shield region 150a and the partial light transmission region 150b is generated after development. In this case, the light shield region 150c has a shape corresponding to the upper electrodes 116 described below.

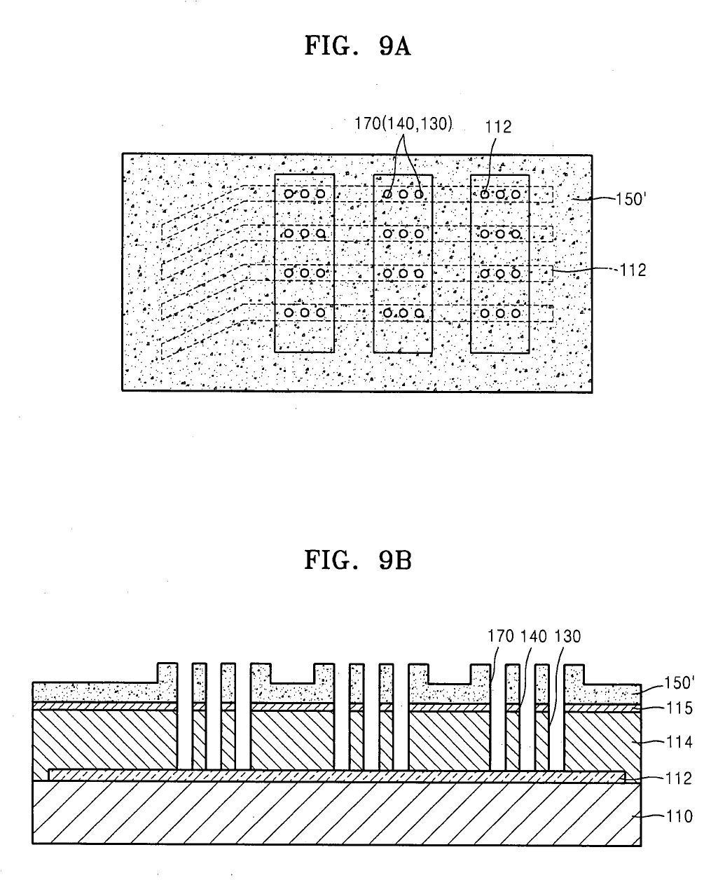

Referring to FIGS. 9A and 9B, the upper electrode material layer 115 exposed through the resist holes 170 and the insulation layer 114 are subsequently etched using the developed photoresist 150′ as an etching mask. In this case, the insulation layer 114 is etched until the lower electrodes 112 are exposed. As a result, the plurality of insulation layer holes 130 exposing the lower electrodes 112 are formed in the insulation layer 114 and upper electrode holes 140 connected to the insulation layer holes 130 are formed in the upper electrode material layer 115.

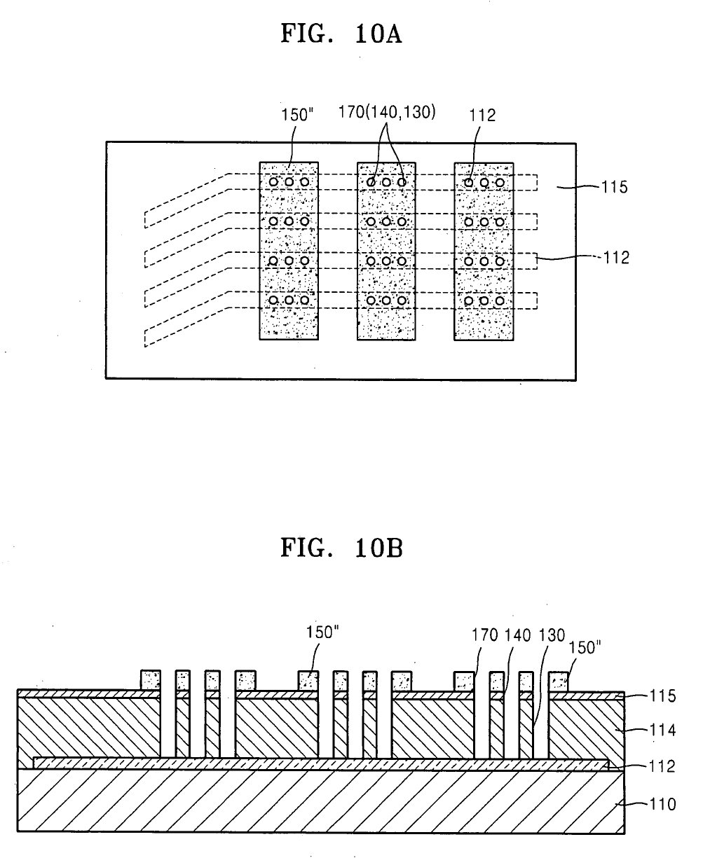

Referring to FIGS. 10A and 10B, a portion of the upper electrode material layer 115 is exposed by etching the developed photoresist 150′. Specifically, the developed photoresist 150′ is etched by a plasma etching method. The plasma etching method can include Reactive Ion Etching (RIE) and the like. By performing this process, the upper surface of the developed photoresist 150′ become lower and the process is continued until the photoresist 150′ of the partial light transmission region 150b is completely dissolved so as to expose the upper electrode material layer 115. However, a portion of photoresist 150′ located in the light shield region 150a remains on the upper electrode material layer 115 having a predetermined thickness in the form of upper electrodes 116 as described below.

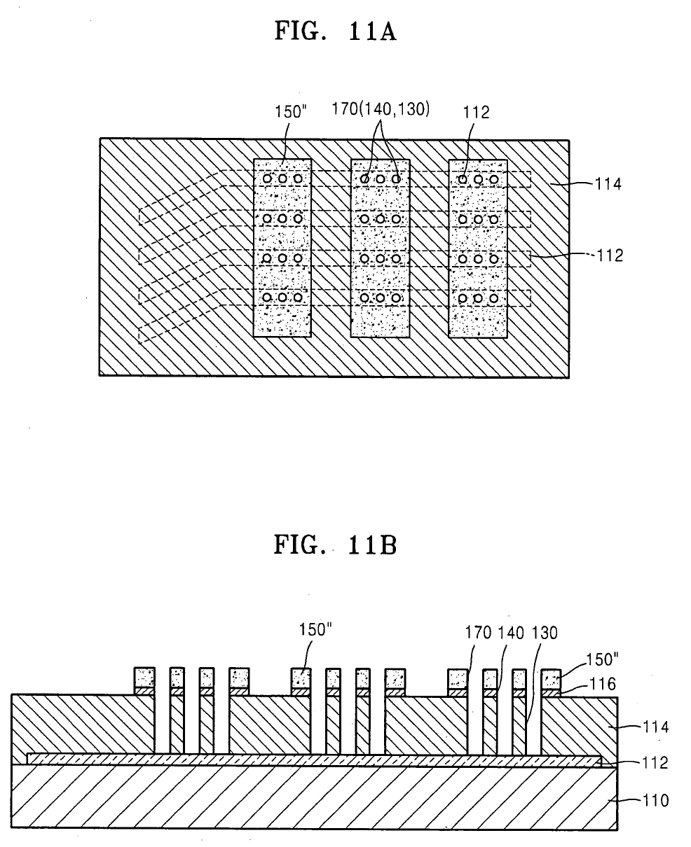

Referring to FIGS. 11A and 11B, a plurality of upper electrodes 115 are formed on the insulation layer 116 by etching the upper electrode material layer 115 using the etched photoresist 150″ as an etching mask. In this case, the upper electrodes 116 can be formed so as to intersect with the lower electrodes 112. The upper electrodes 116 can be gate electrodes for extracting electrons.

Finally, referring to FIGS. 12A and 12B, the photoresist 150″ remaining on the upper electrodes 116 is removed. FIG. 12B is a cross-sectional view taken along line V-V′ of FIG. 12A. Although not illustrated, an emitter is formed on the lower electrodes 112 in the insulation layer holes 130 in a subsequent process and a field emission device is completed.

As described above, since insulation layer holes and upper electrodes can be formed using one halftone photomask according to the present invention, the number of photomasks used can be reduced. Accordingly, the number of processes and costs of manufacturing field emission devices can also be reduced.

While the present invention has been particularly shown and described with reference to exemplary embodiments thereof, it will be understood by those of ordinary skill in the art that various modifications in form and detail may be made therein without departing from the spirit and scope of the present invention as defined by the following claims.

What is claimed is:

1. A method of manufacturing field emission devices, the method comprising:
sequentially forming lower electrodes, an insulation layer, an upper electrode material layer and a photoresist on a substrate;
arranging a halftone photomask above the photoresist and exposing the photoresist to light and developing the photoresist, the photomask having a predetermined pattern including a first pattern shielding light and a second shape through which a portion of light is transmitted;
etching the upper electrode material layer exposed by the developed photoresist and the insulation layer below the upper electrode material layer to form a plurality of insulation layer holes exposing the lower electrodes in the insulation layer;
etching the developed photoresist, the developed photoresist remaining only on a portion of the upper electrode material layer which is to form the upper electrodes;
etching the upper electrode material layer through the etched photoresist to form the upper electrodes; and
removing the photoresist.

2. The method of claim 1, wherein the photoresist comprises a positive photoresist.

3. The method of claim 1, wherein the lower electrodes are formed by depositing a lower electrode material layer on the substrate and patterning the lower electrode material layer in a predetermined shape.

4. The method of claim 1, wherein the first and second patterns are formed on a transparent substrate.

5. The method of claim 4, wherein the first pattern is formed in a shape corresponding to the upper electrodes, and wherein a plurality of through-holes exposing the transparent substrate are formed in the first pattern.

6. The method of claim 5, wherein the through-holes are formed in a shape corresponding to the insulation layer holes.

7. The method of claim 5, wherein the second pattern is formed in a region except for the region of the first pattern.

8. The method of claim 5, wherein the light transmittance of second pattern is in a range of 25 to 80%.

9. The method of claim 5, wherein the photoresist located under the through-holes of the first pattern is exposed to light and developed to expose the upper electrode material layer, and wherein the photoresist located under the second pattern is exposed to light and developed to a depth corresponding to the light transmittance of the second pattern during the exposing of the photoresist to light.

10. The method of claim 1, wherein etching of the developed photoresist is performed by a plasma etching method.

11. The method of claim 10, wherein the plasma etching method comprises Reactive Ion Etching (RIE).

12. The method of claim 1, wherein the upper electrodes are formed to cross the lower electrodes.
